(19) United States
(12) Patent Application Publication
(10) Pub. No.: US 2006/0100805 A1
(43) Pub. Date: May 11, 2006

(54) Enhanced methods for electronic storage device calibrations

(75) Inventors: Fernando A. Zayas, Loveland, CO (US); Patrick Hery, San Jose, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co. Ltd., Osaka (JP)

(21) Appl. No.: 10/985,376

(22) Filed: Nov. 10, 2004

(51) Int. Cl. G01D 18/00

(52) U.S. Cl. 702/85

(57) ABSTRACT

Enhanced calibrations for ESDs are implemented to better performance, power conservation, and efficiency of the ESD. Performing calibrations in an electronic storage device includes triggering a calibration request, receiving a qualifying I/O request, and performing a calibration associated with the calibration request. This conserves power by eliminating a separate power-up of the media every time a calibration is requested. Calibrations can also be performed upon the occurrence of an event, such as the occurrence of an error, data transfer threshold, environment change, or after a certain period of time. The calibrations may be performed along with but immediately before or after the qualifying I/O operation depending on whether the drive is configured for reliability or performance.

### CROSS REFERENCE TO RELATED APPLICATIONS

The present application is related to the following U.S. patents and patent applications, which patents/applications are incorporated by reference herein in their entirety: U.S. patent application Ser. No. ______, entitled “ENHANCED SYSTEM FOR ELECTRONIC STORAGE DEVICE CALIBRATIONS, filed on ______ 2004, Attorney Docket No. PANAP 1032US0, currently pending.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to electronic storage device calibration, and more particularly to electronic storage device calibration for power sensitive devices.

### BACKGROUND OF THE INVENTION

Electronic storage devices (ESD) perform many operations per second. These operations involve moving parts and reading and writing to very small areas on the ESD media, all in an environment having a varying temperature. As a result, ESDs must be undergo calibrations. Traditionally, ESDs perform different types of calibrations at different times. At power-up, electronic storage devices perform bias and RRO compensation calibrations. Periodically, ESDs perform calibrations such as Kt adjustment calibrations. A method 100 illustrating the typical power-up and periodical calibration process of electronic storage devices of the prior art is illustrated in FIG. 1. Method 100 begins with start step 105. Next, the ESD is undergoes power-up at step 110. Typically, power up calibration is immediately performed on the drive at step 120. After the power-up calibrations, typical electronic storage devices of the prior art will perform periodic calibrations. The periodic calibrations are performed at regular intervals determined by the design of the ESD. Once a periodic interval is triggered to be performed at step 130, operation continues to step 140 wherein the drive immediately performs the calibration. Steps 130 and 140 repeat such that calibrations are periodically performed while the drive is powered on.

Though calibrations are useful in maintaining a high level of performance and reliability in the ESD, periodical calibrations can drain power sources when they require a “media power-up” or that the drive be brought to the ready state. Additionally, it can be undesirable for a user to hear an ESD “power-up” on it's own when the user is not initiating any operations or access to the ESD in a device.

Other types of electronic storage device calibrations in the prior art are performed during error recovery. As shown in method 200 of FIG. 2, after the start of operation at step 205, when a drive detects an error has occurred at step 210, a typical universal error-recovery process is initiated at step 220. Operation then ends at step 225. The universal error-recovery process is a list of calibrations that are performed in a fixed order. The calibrations are typically encoded into firmware and are designed to handle all error handling for the ESD. As with power-up and periodical calibrations, error recovery calibrations can drain power sources and waste time. This is especially true when a universal error recovery process that encompasses the entire scope of ESD operation is prescribed for each error detected.

What is needed is an enhanced manner of performing calibrations on a electronic storage device that overcomes the power and implementation limitations of the calibration methods of the prior art.

### SUMMARY OF THE INVENTION

Enhanced calibrations for an electronic storage devices (ESD) are implemented to improve performance, power conservation, and efficiency of the ESD. In one embodiment, calibrations are performed only when a qualifying I/O operation is requested and acted upon. This conserves power by eliminating a separate power-up of the media for the calibration. In another embodiment, calibrations are performed upon the occurrence of an event, such as the occurrence of an error, data transfer threshold, environment change, or after a certain period of time. The calibrations may be performed before or after a qualifying I/O operation. In one embodiment, whether the calibrations are performed before or after an I/O operation depends on whether the drive is configured for reliability or performance. The calibrations performed may include enhanced environment adaptive and enhanced error recovery sequence calibrations.

### BRIEF DESCRIPTION OF THE DRAWINGS

FIG. 1 is an illustration of a method for scheduling drive calibrations in accordance with the prior art.

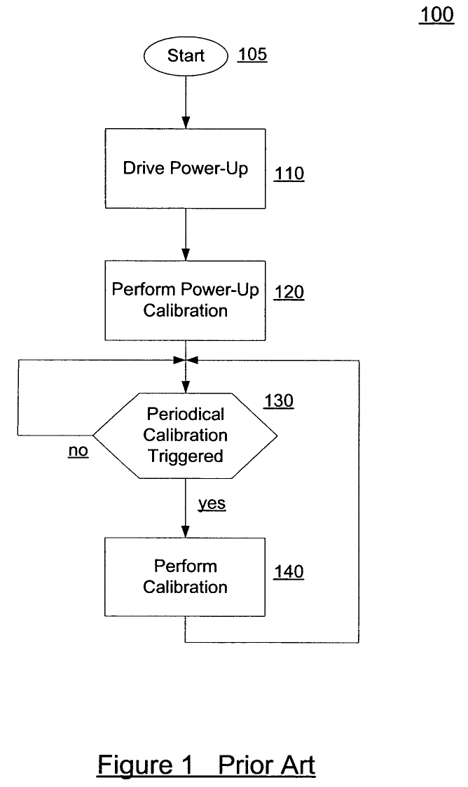

FIG. 2 is an illustration of a method for performing error-recovery in accordance with the prior art.

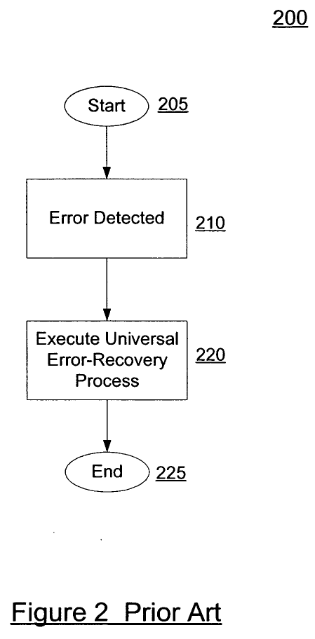

FIG. 3 is an illustration of an electronic storage device of the present invention.

FIG. 4 is an illustration of a method for scheduling of electronic storage device calibrations in accordance with one embodiment of the present invention.

FIG. 5 is an illustration of a method for calibrating a electronic storage device in accordance with one embodiment of the present invention.

FIG. 6 is an illustration of a method for performing enhanced error-recovery in accordance with one embodiment of the present invention.

### DETAILED DESCRIPTION

Enhanced calibrations for an electronic storage devices (ESD) are implemented to improve performance, power conservation, and efficiency of the ESD. In one embodiment, calibrations are performed only when a qualifying I/O operation is requested and acted upon. This conserves power by eliminating a separate power-up of the media for the calibration. In another embodiment, calibrations are performed upon the occurrence of an event, such as the occurrence of an error, data transfer threshold, environment change, or after a certain period of time. The calibrations may be performed before or after a qualifying I/O operation. In one embodiment, whether the calibrations are performed before or after an I/O operation depends on whether the drive is configured for reliability or performance. The calibrations performed may include enhanced environment adaptive and enhanced error recovery sequence calibrations.

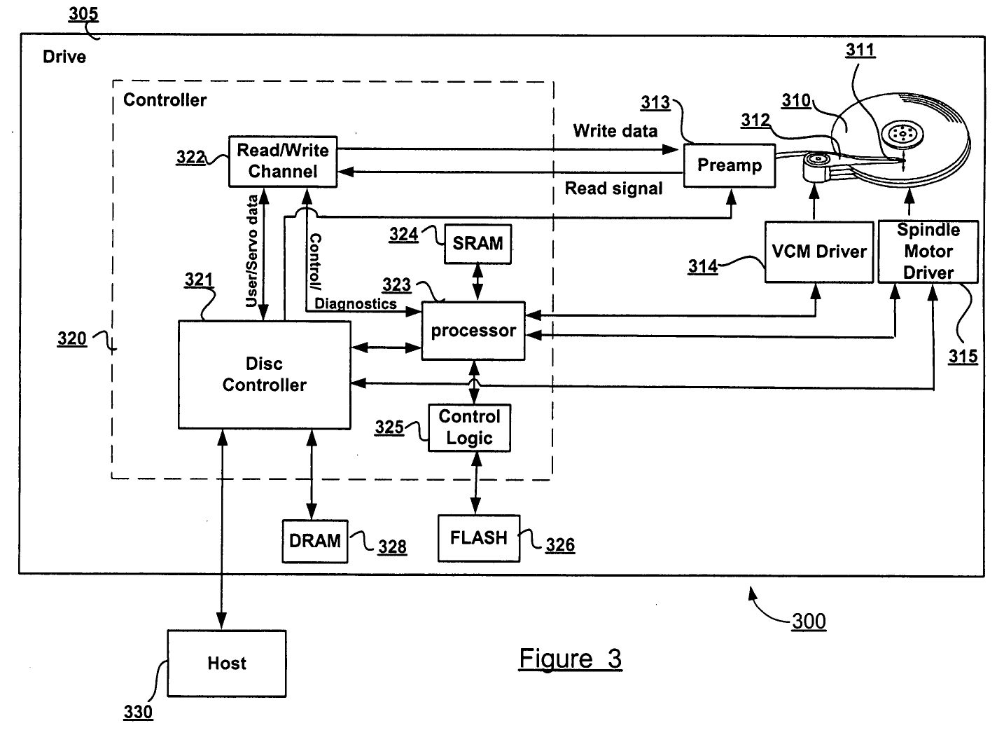

An ESD system 300 in accordance with the present invention is illustrated in FIG. 3. ESD system 300 includes ESD 305, which is comprised of controller circuitry 320, media 310, write and read heads 311, actuator 312, preamp 313, VCM driver 314, spindle motor Driver 315, DRAM 328, and FLASH 326. Controller circuitry 320 includes disk controller 321, read/write channel 322, processor 323, SRAM 324 connected to processor 323, and control logic 325 connected to processor 323 and FLASH 326. A host device 330 is connectively coupled to drive 305. In operation, the disk controller 321 treats DRAM 328 as an intermediate buffer and cache between the media 310 and the host 330 for read and write operations. The processor 323 handles access to FLASH 326 as well as initiating access to media 310 through the disk controller 321, Read/Write Channel 322, Preamp 313, and write and read heads 311.

In one embodiment, the present invention reduces the power required to perform ESD calibrations by performing most if not all calibrations when a qualifying I/O operation is performed. Thus, the ESD does not bring the media and heads to the ready-state solely to perform a calibration operation. Rather, the ESD is brought to the ready state because a qualifying I/O operation needs to be performed, and the calibration is performed at generally the same time. In this manner, power is not spent on brining the ESD to the ready state to perform a calibration.

Calibrations may be performed before or after the qualifying I/O request is performed. Performing the calibration before the I/O operation may improve the reliability of the I/O operation that is performed immediately thereafter, but may cause a delay in completing the requested operation. Performing the calibration after the I/O operation will not delay the I/O operation, but may effect the reliability of the operation performed before the drive is calibrated. Both scenarios conserve power by grouping the calibration with the I/O operation that requires bringing the ESD to the ready state. The decision of which scenario is preferable is a matter of designer or customer preference. In one embodiment, a customer may provide input in the form of a tunable parameter indicating how the drive should operate with respect to two scenarios (i.e., high performance or high reliability or both good performance and good reliability, etc.).

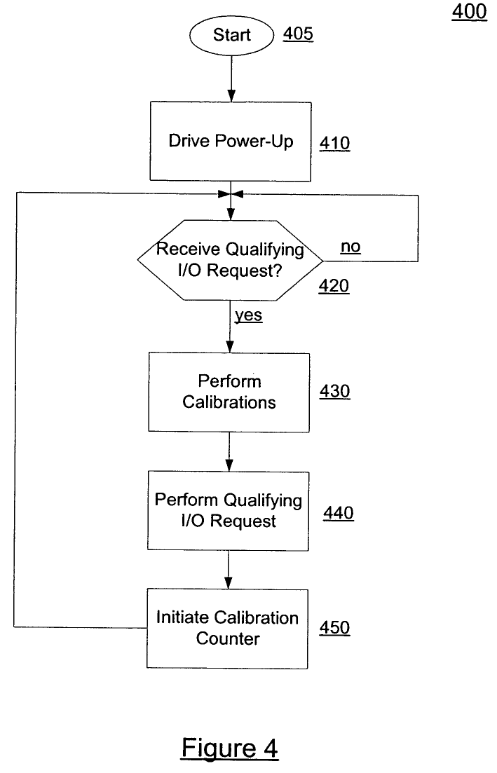

Method 400 of FIG. 4 illustrates a method for performing power-up and periodical calibrations in accordance with one embodiment of the present invention. Method 400 begins with start step 405. The ESD is powered up at step 410. The ESD of the present invention then waits for a qualifying I/O request as illustrated at step 420. In one embodiment, a qualifying I/O request is any message from the host that requires the ESD actuator to move. Thus, the I/O request need not require a transfer of data. In this embodiment, an internally or ESD generated I/O request does not meet this requirement as it is not generated from a host. ESD generated I/O operations may be queued and performed when a qualifying host I/O request is received. In another embodiment, the qualifying I/O request may be satisfied by an ESD generated I/O request, but it will consume more power as more I/O operations will be performed. In yet another embodiment, a qualifying I/O request may be some integral number of requests. For example, a qualifying I/O request may be every one hundred or every one thousand requests. If no I/O request is received, operation remains at step 420. When a satisfactory qualifying I/O request is received at step 420, operation continues to step 430.

Any needed calibrations are performed at step 430. In one embodiment, when a calibration is to be performed, a value is loaded to a calibration register. Different values indicate different types of calibrations to perform upon receiving a qualifying I/O request. Immediately after power-up, one or more values corresponding to one or more power-up calibrations are loaded to the calibration register. Upon receiving the qualifying I/O request at step 420, the ESD will check the calibration register to see if it contains any values indicating that one or more calibrations are to be performed. Once all calibrations specified in the calibration register are performed, the ESD loads a null value to the calibration register.

Once the calibration is performed at step 430, the requested I/O operation is performed at step 440. Operation then continues to step 450 where a calibration counter is initiated. Typically, a calibration may be performed every certain number of media writes or reads, after some period of time, or a combination thereof. After the counter is initiated, operation continues to step 420. If the ESD receives a qualifying I/O request at step 420 after the calibration counter signals a calibration should be performed, the requested calibrations are performed at step 430. If the ESD receives a qualifying I/O request at step 420 before the calibration counter signals a calibration should be performed, no requested calibrations are performed at step 430.

As discussed above, the embodiment illustrated in method 400 FIG. 4 may provide a high reliability I/O operation at step 440. The method of 400 may be altered so that the I/O request is performed before the calibrations are completed (switching the order of steps 430 and 440). Such an embodiment results in a faster completion of the I/O request, but with a performance and reliability potentially less than that of method 400.

At step 450, a calibration counter is initiated. The calibration timer may be a counter of time, host I/O events, ESD I/O events or other countable events. Operation of method 400 then continues to step 420. Once the counter expires, or has reached a number that triggers a calibration, a value for the calibration is loaded into the calibration register. At the next qualifying I/O event, the calibrations are performed at step 430.

In one embodiment, when ESD calibrations are performed only when a host I/O operation is performed, the calibrations may be less susceptible to interruption by the host. This is advantageous in that the calibrations are more likely to complete once they are started and less likely to conflict with a host I/O operation. This would not be practical on ESDs of the prior art because the calibrations are not scheduled around host I/O operations, and are thus more susceptible to occurring at exactly the same time.

In one embodiment, the high performance and high reliability calibration method of the present invention can include an optional step that performs a calibration upon the expiration of a period of time or the occurrence of an event. The event can be a change in conditions, the transfer of a certain quantity of data, the detection of an error, or some other event. In another embodiment, the ESD may include a programmable setting that determines how the drive balances energy conservation with performance. For example, when the programmable setting is set to strongly favor higher performance, the drive may be configured to do calibrations upon receiving I/O requests more frequently (i.e., most or all I/O operations). When the programmable setting is set to favor energy conservation, the drive will perform a minimum number of calibrations (i.e., only do calibrations every one thousand requests). Minimal calibrations translate to power savings by requiring less actuator movement.

One event that may trigger a calibration is a change of environmental conditions or temperature in the ESD. A change in temperature is important because it changes the ESD coil resistance and resulting maximum current available to drive the actuator, thereby affecting the performance of the ESD. Once the temperature is known, the maximum available current and actuator acceleration can be readily determined. The drive may then be calibrated to operate with the maximum acceleration.

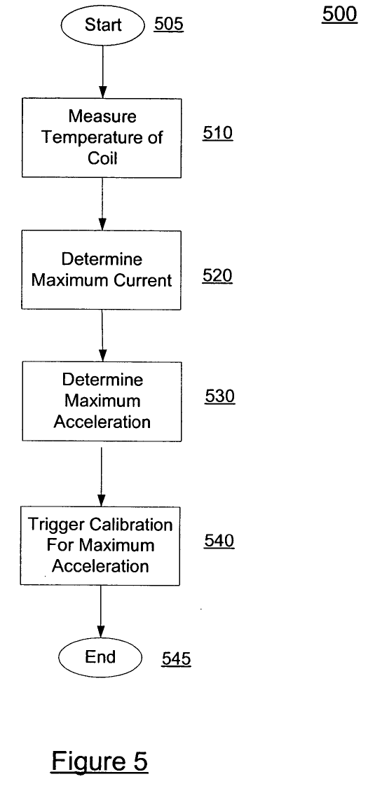

The calibration can be based on an adoptive algorithm used dynamically with a seek. Method 500 of FIG. 5 illustrates the adaptive algorithm in accordance with one embodiment of the present invention. Method 500 begins with start step 505. Next, the temperature of the coil within the ESD is measured at step 510. The temperature of the coil can be measured with temperature sensors as known in the art. The maximum current is then determined from the temperature of the coil at step 520. From the maximum current, the maximum acceleration of the actuator is determined at step 530. Once the actuator acceleration is known, the drive can be calibrated for maximum acceleration. An appropriate calibration is then triggered at step 540. Operation of method 500 then ends at step 545. In one embodiment, the calibration may be triggered at increments of temperature changes, at specific temperatures, or a combination thereof. In another embodiment, the appropriate calibration request may be loaded into the calibration register at step 540. The calibration would then be performed at step 430 according to method 400.

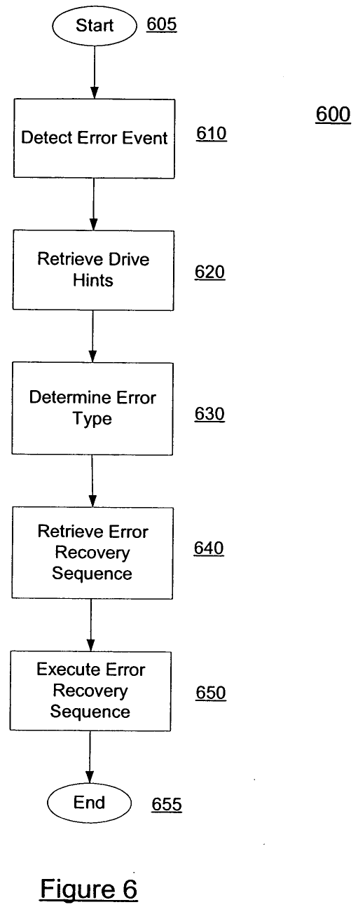

Calibrations in the present invention can be triggered from the detection of an error. In one embodiment, an error recovery sequence is customized depending on the conditions of the error detected. This is accomplished by detecting the error conditions such as when and where the error occurred, and taking steps to recover from the error based on the detected conditions. A custom error recovery sequence attempts to address different detected errors. For example, a seek timeout is typically due to a ringing event. Accordingly, upon detecting the ringing event, an error recovery sequence that performs an RO calibration is executed. Method 600 of FIG. 6 illustrates a process for performing error recovery sequence calibrations in accordance with one embodiment of the present invention.

Method 600 begins with start step 605. Next, an error event is detected in step 610. In one embodiment, the error detection includes determining what type of error has occurred. Drive hints are then retrieved at step 620. The drive hints relate to the error conditions, such as what operation was being attempted by the drive, information from the ESD log and event handler, and other hint information. For example, in one embodiment, a seek timeout error may typically occur due to a ringing event. Accordingly, a note in the form of setting a number of bits in a register is made in response to the ringing event. The error recovery system looks up the appropriate error recovery sequence that corresponds to the ringing event. In this case, an RO calibration error recovery sequence may be performed. Once the hints are retrieved, the ESD can determine the error type of error, if not already known, at step 630. In one embodiment, the ESD may maintain a table of hints and the corresponding error types that usually occur for the particular hints. Next, the error recovery sequence may be retrieved at step 640. In one embodiment, a table of types of errors and corresponding error recovery sequences may be maintained by the ESD, from which the error recovery sequence may be retrieved. After the specific type of error recovery sequence is determined, the sequence is executed at step 650. Operation of method 600 then ends at step 655. In one embodiment, rather than execute the error recovery sequence at step 640, a value corresponding to the particular sequence is written to the calibration register. The particular error recovery sequence would then be performed in due course in method 400.

In some instances, more than one type of error recovery sequence may be possible for a type of error. In one embodiment, the calibration execution order may be changed so that calibrations that have been most successful for a particular error are performed first. In this case, the ESD may contain information in the form of a table regarding which error recovery sequence has been most successfully hinted. Upon performing error recovery calibrations, the order is configured appropriately and the error recovery sequences are carried out.

In another embodiment, after execution of the error recovery sequence at step 650, the ESD would check to see if execution of the error recovery sequence was successful in correcting the error. If the error recovery sequence was successful, then operation would end. If the error recovery sequence was not successful, then operation would continue by performing a full scale comprehensive error recovery sequence that covers the entire ESD.

Enhanced calibrations for an ESD are implemented to improve performance, power conservation, and efficiency of the ESD. In one embodiment, calibrations are performed only when a qualifying I/O operation is requested and acted upon. This conserves power by eliminating a separate power-up of the media for the calibration. In another embodiment, calibrations are performed upon the occurrence of an event, such as the occurrence of an error, data transfer threshold, environment change, or after a certain period of time. The calibrations may be performed before or after a qualifying I/O operation. In one embodiment, whether the calibrations are performed before or after an I/O operation depends on whether the drive is configured for reliability or performance. The calibrations performed may include enhanced environment adaptive and enhanced error recovery sequence calibrations.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to, enhanced calibration methods in ESDs.

1. A method for performing calibrations in an electronic storage device, comprising
triggering a calibration request;
receiving a qualifying I/O request; and
performing a calibration associated with the calibration request.

2. The method of claim 1 wherein triggering a calibration request includes:
triggering a power-on calibration request.

3. The method of claim 1 wherein triggering a calibration request includes:
triggering a calibration as a result of detecting an error.

4. The method of claim 1 wherein triggering a calibration request includes:
triggering a calibration request as a result of a calibration counter event.

5. The method of claim 1 wherein receiving a qualifying I/O request includes:
receiving a host I/O request.

6. The method of claim 1 further comprising:
performing the qualifying I/O request after receiving the qualifying I/O request, the qualifying I/O request including a host I/O request, wherein ESD generated I/O requests are placed in a queue and performed after receiving the qualifying I/O request.

7. The method of claim 1, further comprising:
performing the qualifying I/O request before performing the calibration but after receiving the qualifying I/O request.

8. The method of claim 1, further comprising:
performing the qualifying I/O request after performing the calibration.

9. The method of claim 1 further comprising:
writing to calibration value to a calibration register, the calibration value indicating the type of calibration to be performed.

10. The method of claim 1 wherein the calibration includes:
calibrating an actuator to operate at a maximum acceleration at a particular ESD coil temperature.

11. The method of claim 1 wherein triggering a calibration includes:
measuring a current temperature of an ESD coil;
determining the maximum current in the coil from the current temperature; and
determining the maximum acceleration of the actuator from the maximum current.

12. The method of claim 1 wherein triggering a calibration includes:
detecting an error event;
retrieving drive hints;
determining an error type associated with the error event; and
executing an error recovery sequence associated with the error type.

13. A method for handling errors in an electronic storage device, comprising:
detecting an error event associated with an error;
retrieving drive hints;
determining an error type associated with the error event; and
executing one of a plurality of error recovery sequences, the executed error recovery sequence associated with the determined error type.

14. The method of claim 13 wherein retrieving drive hints includes:
retrieving information from an electronic storage device log.

15. The method of claim 13 wherein determining an error type includes:
providing a table including drive hints and associated error types; and
retrieving an error type associated the retrieved drive hints.

16. The method of claim 13, further comprising:
determining that the error recovery sequence did not correct the error; and
executing a comprehensive error recovery sequence.
